(19) United States
(12) Patent Application Publication
(10) Pub. No.: US 2022/0326679 A1
(43) Pub. Date: Oct. 13, 2022

(54) METHOD AND OPERATING SYSTEM FOR SETTING UP A MACHINING DEVICE, MACHINING DEVICE, AND COMPUTER PROGRAM FOR SETTING UP A MACHINING DEVICE

(71) Applicant: HOMAG Bohrsysteme GmbH, Herzebrock-Clarholz (DE)

(72) Inventors: Bernd AMANN, Minden (DE); Werner DÜPJOHANN, Herzebrock-Clarholz (DE); Bernd LEMKE, Herrenberg (DE)

(21) Appl. No.: 17/613,931

(22) PCT Filed: May 20, 2020
(86) PCT No.: PCT/EP2020/064121

§ 371 Date: Nov. 23, 2021

(30) Foreign Application Priority Data
May 24, 2019 (DE) 10 2019 113 933.3

(51) Int. Cl. G05B 19/402; B23Q 15/12

(52) U.S. Cl. CPC G05B 19/402; B23Q 15/12; G05B 2219/36088

(57) ABSTRACT

The invention relates to a method for setting up a machining device (10), in particular a machining device (10) for machining workpieces (11) which are at least partially made of wood, wood materials, synthetic material, composite materials or the like, comprising the steps of optically detecting the machining device (10) at least in some areas by means of an image capture device (13); detecting, by means of the image capture device (13), an individual first gesture (21) of an operator of the machining device (10) that is performed in the optically detected area; and triggering at least one function of the machining device (10) depending on the detected individual first gesture (21), and to an operating system (12) for setting up a machining device (10), a machining device (10) and a computer program for setting up a machining device (10).

The invention relates to a method for setting up a machining device, an operating system for setting up a machining device, a machining device for machining workpieces as well as a computer program for setting up a machining device.

Known from DE 10 2014 204 695 A1 is a machining device for machining plate-shaped workpieces. This machining device comprises an image capture device which optically monitors the machining device, in particular parameters of the machining process. These parameters are used for automated control and regulation of the machining device so that the machining process can be monitored and, if necessary, corrected and optimized without the intervention of an operator. If automatic correction or optimization is not possible, instructions are automatically displayed to an operator via a display device.

An object of the present invention is to propose a method which allows for a simple and intuitive setting up of a machining device by an operator. A further object of the invention is to propose an operating system as well as a machining device, by means of which such a simple and intuitive setting up by an operator is made possible. Furthermore, it is the object of the invention to propose a computer program, by means of which a simple and intuitive handling is achieved.

This object is solved by a method for setting up a machining device, in particular a machining device for machining workpieces which are at least partially made of wood, wood materials, synthetic material, composite materials or the like, wherein the machining device is optically detected at least in some areas by an image capture device; an individual first gesture of an operator of the machining device that is performed in the optically detected area is detected by the image capture device, and at least one function of the machining device is triggered depending on the detected gesture. With such a method, a gesture control can be formed, by means of which a particularly simple and intuitive setting up of the machining device can be made possible. Owing to the fact that the operator can perform the individual gesture in the optically detected area, i.e. directly at the machining device, a local separation of work steps for setting up the machining device can also be avoided. A significant simplification of the work required to set up the machining device can thereby be achieved for the operator. By having the image capture device monitor the machining area, incorrect operation by the operator can also be prevented by having the operator's work steps controlled accordingly by the image capture device and/or the control device.

In a preferred embodiment of the method, it can be provided that a display device outputs, depending on the detected individual first gesture of the operator, visual, acoustic and/or haptic information for setting up the machining device. As a result of such a presentation of information, the operator can receive a direct feedback regarding the performed and detected gesture. In particular by visually displaying the information, interactive setting up of the machining device by the operator is made possible.

One advantageous embodiment of the method can provide that the display device projects the information onto a machining area of the machining device and/or onto the workpiece provided in the machining area. The machining area is not only understood to mean the area for machining the workpiece, but also the area in which the operator moves to set up the machining device. Particularly when the information is projected onto the workpiece, the setting up of the machining device by the operator can be performed in direct interaction with the workpiece. A particularly simple and intuitive setting up of the machining device can thus be achieved.

A further advantageous embodiment of the method can provide that a defined information is selected by at least one further gesture of the operator, preferably by a hand movement, a pointing movement or touching of a surface of the workpiece or of the machining device in the area of the projected information to be selected, wherein the information is linked in each case to at least one function relating to the machining process of the workpiece. In this manner, an interactive setup of the machining device by the operator is made possible in that the operator can select, control and/or machine required information by performing a corresponding gesture, without having to use further means such as a keyboard or an external screen.

In a particularly preferred embodiment of the method, it can be provided that by performing and detecting the individual first gesture, an input mask and/or keyboard are projected onto the machining area of the machining device and/or onto the workpiece provided in the machining area, wherein at least one function relating to the machining process of the workpiece is programmed via the input mask and/or keyboard and by the performance and detection of the at least one further gesture. This also allows for an extensive and complex setting up of the machining device, as is the case, for example, in a machining process comprising multiple machining steps, or also when programming the machining process.

This object is also solved by an operating system for setting up a machining device, in particular a wood working device, having an image capture device, by means of which at least a partial area of the machining device can be optically detected, as well as a display device, by means of which optical, acoustic and/or haptic information for setting up the machining device can be output in a machining area of the machining device, wherein the setting up of the machining device is provided according to one of the embodiments of the method described above. Such an operating system can be easily provided in a machining device; it can also, for example, be refitted so that the machining device can be set up by an operator using intuitive gesture control.

The object is further solved by a machining device for machining workpieces, in particular workpieces which are at least partially made of wood, wood materials, synthetic material, composite materials or the like, having an image capture device which optically detects at least a partial area of the machining device, as well as a display device, by means of which optical, acoustic and/or haptic information for setting up the machining device can be output in a machining area of the machining device, wherein the setting up of the machining device is provided according to one of the embodiments of the method described above. Such a machining device enables the operator to set up the machining device directly in the machining area, wherein the image capture device allows for the setting up by detecting gestures, and interaction between the operator and the machining device can be provided by the display device. By means of the display device, a variety of information can be directly shown to the operator in the machining area and provides him/her with immediate feedback on the detected gesture.

In an advantageous further development of the machining device, it can be provided that the machining device is CNC controlled or is configured as a CNC controlled machining center or is a unit of a CNC controlled machining center. This enables automated control of the machining device. By using the CNC control or by integrating the machining device into a CNC controlled machining center, partially or fully automated machining of the device can be provided. The CNC control moreover also allows complex workpiece geometries to be machined automatically.

Additionally, the object is solved by a computer program for setting up a machining device, in particular a machining device according to one of the embodiments described above, which is stored in a control device of the machining device, wherein a method according to one of the embodiments described above can be executed by the computer program. By means of such a computer program, gesture control for setting up the machining device can be formed. The computer program can thereby link a large number of different gestures to corresponding functions of the machining device, and thus these functions can be triggered by the computer program and executed on the machining device when a corresponding gesture is performed.

The invention as well as further advantageous embodiments and further developments thereof will be described and explained in more detail below on the basis of the examples shown in the drawings. The features that are apparent from the description and the drawings can be applied individually or jointly in any combination in accordance with the invention. The drawings show the following:

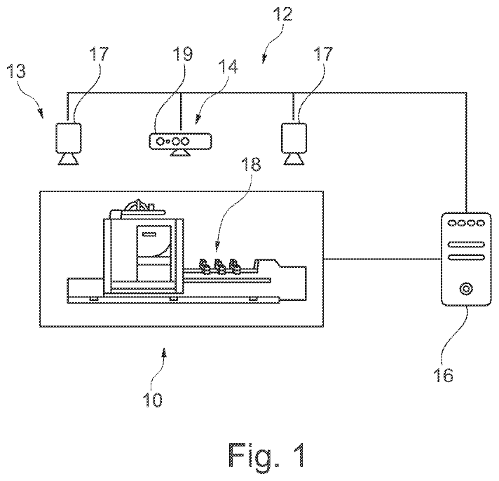

FIG. 1 a schematic view of a machining device with an operating system,

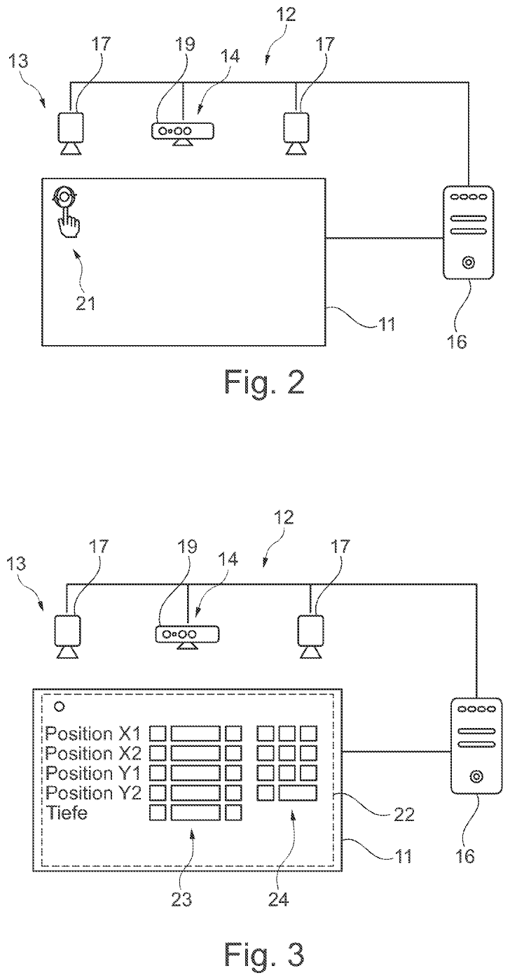

FIG. 2 an exemplary representation of a first method step for setting up the machining device according to FIG. 1,

FIG. 3 a schematic representation of a method step for setting up the machining device following the method step according to FIG. 2,

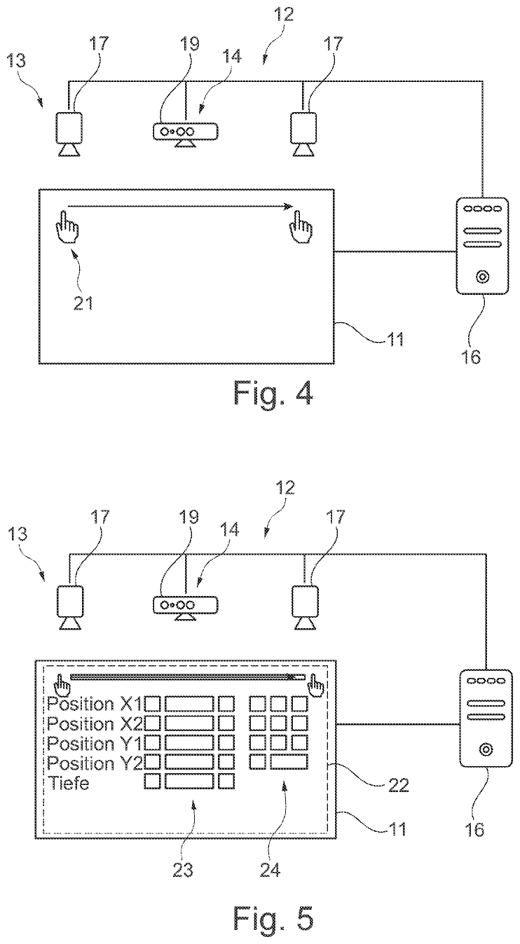

FIG. 4 an exemplary representation of an alternative first method step for setting up the machining device, and

FIG. 5 a schematic representation of a method step for setting up the machining device following the method step according to FIG. 4.

FIG. 1 shows a schematic view of a machining device 10. This machining device 10 may be any device for machining workpieces 11, in particular plate-shaped workpieces 11. The machining device 10 may in particular be configured as a CNC controlled machining device 10 or may be a unit of a CNC controlled machining center or may form a CNC controlled machining center. By means of the machining device 10, the machining of workpieces 11 can alternatively also be provided in a continuous process. During this process, the workpiece is moved relative to the machining device 10. In this context, machining of the workpiece 11 is understood to mean, in particular, cutting, sawing, milling, drilling, gluing, coating, edging or comparable machining operations.

Preferably, the machining device 10 is provided for machining workpieces 11 which are at least partially made of wood, wood materials, synthetic material, composite materials or the like. Such workpieces 11 are used, for example, in the field of furniture and components manufacturing. These can be a wide variety of workpieces 11, for example solid wood or chipboard, lightweight boards, sandwich boards, skirting boards, profiles for profile wrapping and the like. However, the present invention is not limited to such workpieces 11.

The machining device 10 comprises an operating system 12 for setting up or operating the machining device 10. Setting up or operating the machining device 10 is understood to mean in particular a control, regulation and/or programming of the machining device 10, in particular of the process for machining the workpiece 11 by an operator. The operating system 12 comprises an image capture device 13 and a display device 14. This image capture device 13 and display device 14 are connected to the machining device 10 via a control device 16.

The image capture device 13 comprises cameras 17 which optically capture the machining device 10 at least in some areas. The image capture device 13 particularly captures a machining area 18 of the machining device 10. This machining area 18 is preferably a support, console or a machining table on which the workpiece 11 is placed by the operator or automatically, and is prepared for the machining process and/or subsequently machined. The machining area 18 can also be understood as an area surrounding the machining device 10, in which the operator moves to set up the machining device 10.

As shown in FIG. 1, the image capture device 13 may comprise two cameras 17. The cameras 17 are arranged at a distance from each other and are provided, for example, above the machining device 10. More than two cameras 17 or, if necessary, only one camera 17 may also be provided. In particular, the image capture device 13 or the cameras 17 are also set up to detect movements that occur in the optically detected area. By means of the control device 16, the detected movements, for example gestures of the operator, are processed and the operating device 10 and or the display device 14 driven accordingly.

The display device 14 comprises a projector 19 such as a laser projector, LED projector, or similar projection device. Preferably, the display device 14 is arranged above the machining device 10. In particular, the display device 14 is arranged in such a way that it can output, in particular display or project, information 22 into the machining area 18.

In addition, the display device 14 can be provided to output acoustic and/or haptic information. Acoustic information can be, for example, signals or tones that convey particular information to the operator. Haptic information can be conveyed to the operator, for example, by a vibration of at least parts of the machining device 10, in particular a vibration of the support, console or machining table or of an input device.

The setting up of the machining device 10 using the operating system 12 will hereinafter be explained by means of FIGS. 2 to 5. In this regard, it is to be noted that the explanations for setting up the machining device 10 are provided using two individual gestures 21 as an example, wherein each individual gesture 21 is assigned one or more functions for controlling and/or regulating the machining device 10. A large number of further gestures 21 can also be provided, to which corresponding functions for controlling and/or regulating the machining device 10 are assigned.

FIG. 2 schematically shows the performance of an individual gesture 21 by the operator in an area optically detected by the image capture device 13. The workpiece 11 is located within the optically detected area, wherein the gesture 21 is performed with respect to the workpiece 11. For example, the gesture 21 can be performed in the form of a pointing movement. According to FIG. 2, the operator draws an imaginary circle with a finger at a specific position on the workpiece 11. The image capture device 13 thereby detects the type of gesture 21 performed and/or the position of the gesture 21. The gesture 21 is associated with a defined function in the control device 16 that is triggered by the performance and capture of the gesture 21. Drawing the circle on the surface of the workpiece 11 may, for example, be associated with the function of providing a hole in the workpiece 11 at this position by the machining device 10.

To perform the function, it may be necessary to program the machining device 10 with further defined parameters. Using the example of the borehole, this can be the exact position of the borehole, the borehole diameter, the borehole depth, a sinking of the borehole or similar parameters. In order to program these parameters, a control of the display device 14 is carried out depending on the detected gesture 21. The display device 14 projects information 22 associated with the detected gesture 21 onto a surface of the workpiece 11. In particular, the information 22 is displayed two-dimensionally on the surface of the workpiece 11, comparable to a virtual window on a computer screen. This is schematically shown in FIG. 3. The information 22 may be, for example, an input screen 23 projected onto the surface of the workpiece 11 and/or a projected keyboard 24 for entering parameters.

Entering the parameters is carried out by a further gesture 21, in particular by a pointing movement at the position of the projected information 22 to be selected or entered. This further gesture 21 is also detected by the image capture device 13, and a function associated with the selected or input information 22 is triggered. According to FIG. 3, the operator can use the keyboard 24 projected onto the workpiece 11 to program individual parameters relating to the position of the hole in the X1 and X2 directions, in the Y1 and Y2 directions, and the depth of the hole. It goes without saying that the information 22 can comprise any parameters relating to the machining process of the workpiece 11, for example also “shortcuts” for a quick selection or supplementary information about the machining process. In a more complex configuration of the machining device 10, it may also be provided that the operator is guided through a kind of menu, i.e. information 22 is successively projected onto the workpiece 22, and the operator performs a corresponding programming of parameters by performing gestures 21.

Finally, the programmed parameters can be confirmed by means of a further gesture 21 detected by the image capture device 13, and thus the machining process of the workpiece 11 is started by the machining device 10.

FIGS. 4 and 5 show the setting up of the machining device 10 by means of a further individual gesture 21, wherein the method is in principle carried out in the same way as described previously with respect to FIGS. 2 and 3. According to FIG. 4, the individual gesture 21 is performed by a pointing movement in which the operator moves his finger along a side area of the workpiece 11, thus drawing an imaginary line along the side area. The image capture device 13 detects the type of the performed gesture 21 and/or the position of the gesture 21, whereby a defined function associated with the gesture 21 is triggered in the control device 16. Drawing the line on the surface of the workpiece 11 can, for example, be linked to the function of providing a saw cut on the workpiece 11.

In order to program the machining device 10 with the parameters required for the saw cut, the display device 14 is triggered depending on the detected gesture 21, wherein the display device 14 projects the information 22 associated with the detected gesture 21 onto the surface of the workpiece 11. The information 22 can again be an input mask 23 projected onto the surface of the workpiece 11 and/or a projected keyboard 24 for entering parameters concerning the saw cut, as already described with respect to FIG. 3.

In the following, some further individual gestures 21 are listed by way of example, by means of which corresponding functions for setting up the machining device 10 can be triggered, wherein the gestures 21 are performed on the surface of the workpiece 11, and the list is to be considered as non-exhaustive:
Gesture: Draw a rectangle
Function: Machining of a contour of the workpiece

Gesture: Tapping a drill hole in the workpiece
Function: Gluing the drill hole

Gesture: Drawing a rectangle around a hinge hole
Function: Setting a hinge

Gesture: Drawing a line along an edge of the workpiece
Function: Providing edge material at the edge

Gesture: Drawing a question mark
Function: Help menu is opened

Gesture: Drawing a line starting from an edge of the workpiece
Function: Input menu is opened

Gesture: Double-tapping the workpiece with the finger
Function: Selection of a specific information

Gesture: Drawing a “C”
Function: Copy all programmed functions for another workpiece

Gesture: Drawing an arc-shaped line
Function: Mirroring of programmed functions to an opposite workpiece side

Gesture: Drawing an “X”
Function: Delete a programmed function

By means of the image capture device 13 and/or the display device 14, further information 22 can additionally also be output or functions performed. In particular, it is thereby provided that by means of the projected information 22 and/or the performance and capture of the gestures 21, the operator is guided in a largely automated manner through the setting up of the machining process for the workpiece 11.

By means of the image capture device 13, for example, clamping means for holding the workpiece 11 can be detected, wherein depending on the position of the clamping means required for holding the workpiece 11, missing and/or incorrectly positioned clamping means can be indicated to the operator by a corresponding projection of the display device 14. It can thereby be provided that the control device 16 automatically activates a successive function as soon as all clamping devices are correctly positioned by the operator.

It may also be provided that the display device 14 projects the outline of the workpiece 11 in the required position into the machining area 18 of the machining device 10. In this way, simple and precise positioning of the workpiece 11 can be performed by the operator. In addition, dimensions can also be projected into the machining area 18 of the machining device 10. When the workpiece 11 is correctly positioned, the operator may receive visual, audible, and/or haptic feedback from the display device 14.

The display device 14 can also output information 22 comprising further parameters relating to the machining process. These can be, for example, a remaining time of the machining process, safety instructions, context information on the machine status, error messages and the like.

In an alternative embodiment of the machining device 10, it may further be provided that the gestures 21 are not detected by the previously described operating system 12, but that the operator performs the gestures 21 on a sensitive surface, in particular a tablet or touchscreen. Such an embodiment can also be easily integrated into existing machining devices 10 or, if necessary, refitted.

List of reference numbers
10. machining device
11. workpiece
12. operating system
13. image capture device
14. display device
15.
16. control device
17. camera
18. machining area
19. projector
20.
21. gesture
22. information
23. input mask
24. keyboard

1. Method for setting up a machining device comprising the steps of
optically detecting the machining device at least in some areas by means of an image capture device,
detecting, by means of the image capture device, an individual first gesture of an operator of the machining device that is performed in the optically detected area, and
triggering at least one function of the machining device depending on the detected gesture.

2. Method according to claim 1,
wherein
depending on the individual first gesture of the operator, a display device outputs optical, acoustic and/or haptic information for setting up the machining device.

3. Method according to claim 2,
wherein
the display device projects the information onto a machining area of the machining device and/or onto the workpiece provided in the machining area.

4. Method according to claim 2 or 3,
wherein
a defined information is selected by at least one further gesture of the operator wherein the information is each linked to at least one function relating to the machining process of the workpiece.

5. Method according to one of the preceding claims,
wherein
by performing and detecting the individual first gesture, an input mask and/or keyboard is projected onto the machining area of the machining device and/or onto the workpiece provided in the machining area wherein at least one function relating to the machining process of the workpiece is programmed via the input mask and/or keyboard and by the performance and detection of the at least one further gesture.

6. Operating system for setting up a machining device, in particular a wood working device, having an image capture device, by means of which at least a partial area of the machining device can be optically detected, and a display device, by means of which optical, acoustic and/or haptic information for setting up the machining device can be output in a machining area the machining device,
wherein
the setting up of the machining device provided according to the method of claim 1.

7. Machining device for machining workpieces, having an image capture device, which optically detects at least a partial area of the machining device, and a display device, by means of which optical, acoustic and/or haptic information for setting up the machining device can be output in a machining area of the machining device,
wherein
the setting up of the machining device is provided according to the method of claim 1.

8. Machining device according to claim 7,
wherein
the machining device is CNC controlled or is configured as a CNC controlled machining center or is a unit of a CNC controlled machining center.

9. Computer program for setting up a machining device, that is stored in a control device of the machining device,
wherein
a method according to claim 1 can be executed.

10. Method according to claim 1, wherein the machining device is a machining device for machining workpieces which are at least partially made of wood, wood materials, synthetic material or composite materials.

11. Method according to claim 4, wherein the further gesture of the operator is a hand movement, a pointing movement or touching of a surface of the workpiece or of the machining device in the area of the projected information to be selected.

12. Operating system according to claim 6, wherein the machining device is a wood working device.
